(19) United States
(12) Patent Application Publication
(10) Pub. No.: US 2021/0306576 A1
(43) Pub. Date: Sep. 30, 2021

(54) SYSTEMS AND METHODS FOR SELECTIVELY ACCESSING CIRCUITRY BLOCKS

(71) Applicant: SEMICONDUCTOR COMPONENTS INDUSTRIES, LLC, Phoenix, AZ (US)

(72) Inventor: Andrew David TALBOT, Chieveley (GB)

(73) Assignee: SEMICONDUCTOR COMPONENTS INDUSTRIES, LLC, Phoenix, AZ (US)

(21) Appl. No.: 16/830,754

(22) Filed: Mar. 26, 2020

(51) Int. Cl. H04N 5/341

(52) U.S. Cl. CPC H04N 5/341

(57) ABSTRACT

An electronic system such as an imaging system may include processing circuitry and memory circuitry. A portion of the electronic device may be formed from a stamp-and-repeat structure. As an example, an integrated circuit die in the electronic device may be formed from multiple identical circuitry block unit cells. Block access circuitry may be used to selectively access one or more (e.g. a subset) of the identical circuitry blocks. The block access circuitry may include data input circuitry, data output circuitry, and data loop-back circuitry. The block access circuitry may be formed from a serial chain of data storage circuits that selectively provides enable signals to the one or more circuitry blocks being accessed. The serial chain of data storage circuits may receive and store different sets of enable bits.

### BACKGROUND

This relates generally to electronic systems built from circuitry block unit cells, and more specifically, systems and methods for selectively accessing one or more specific circuitry block unit cell within the electronic system.

Modern electronic devices such as cellular telephones, cameras, and computers can use electronic systems such as imaging systems, power management systems, and other systems having integrated circuits. These devices can include more complex circuitry formed using a “stamp and repeat” process that builds the larger and more complex circuitry by repeatedly assembling a same smaller and simpler building block circuitry (e.g., repeatedly forming a circuitry block unit cell). These blocks can be identical without customization.

Difficulties can arise when delivering information to or receiving information from one or more specific circuitry blocks in the set of circuitry blocks, as (without customization) there are no uniquely identifiable features between the circuitry blocks. While fixed and complex pass-through signal paths can be used, these signal paths lack configurability and scalability, and are difficult to incorporate into the design tool flow.

It would therefore be desirable to provide improved systems and methods for selectively accessing one or more specific (unit cell) circuitry blocks within a set of such circuitry blocks.

### BRIEF DESCRIPTION OF THE DRAWINGS

FIG. 1 is a diagram of an illustrative electronic device having an imaging system in accordance with some embodiments.

FIG. 2 is a diagram of illustrative imaging circuitry for generating image signals in a camera module such as the camera module shown in FIG. 1 in accordance with some embodiments.

FIG. 3 is a diagram of illustrative block access circuitry configured to selectively access different subsets of circuitry blocks in a set of circuitry blocks in accordance with some embodiments.

FIG. 4 is an illustrative timing diagram for operating block access circuitry such as the block access circuitry shown in FIG. 3 in accordance with some embodiments.

FIG. 5 is a diagram of an illustrative serial latch chain for block access circuitry such as the block access circuitry shown in FIG. 3 in accordance with some embodiments.

FIG. 6 is an illustrative timing diagram for operating a serial latch chain such as the serial latch chain shown in FIG. 5 in accordance with some embodiments.

FIG. 7 is a diagram of illustrative data write circuitry for block access circuitry such as the block access circuitry shown in FIG. 3 in accordance with some embodiments.

FIG. 8 is an illustrative timing diagram for operating data write circuitry such as the data write circuitry shown in FIG. 7 in accordance with some embodiments.

FIG. 9 is a diagram of illustrative data read circuitry for block access circuitry such as the block access circuitry shown in FIG. 3 in accordance with some embodiments.

FIG. 10 is an illustrative timing diagram for operating data read circuitry such as the data read circuitry shown in FIG. 9 in accordance with some embodiments.

FIG. 11 is a diagram of illustrative data loop-back circuitry for block access circuitry such as the block access circuitry shown in FIG. 3 in accordance with some embodiments.

FIG. 12 is an illustrative timing diagram for operating data loop-back circuitry such as the data loop-back circuitry shown in FIG. 11 in accordance with some embodiments.

### DETAILED DESCRIPTION

Embodiments of the present invention relate to block access circuitry configured to selectively access one or more circuitry blocks in a set of the circuitry blocks (e.g., a subset of specific circuitry block unit cells within a set of circuitry block unit cells). It will be recognized by one skilled in the art that the present exemplary embodiments described herein may be practiced without some or all of these specific details. In other instances, well-known operations have not been described in detail in order not to unnecessarily obscure the present embodiments.

The block access circuitry and “stamp and repeat” structures (i.e., larger structures formed from smaller unit cell structures or circuitry blocks) described herein may generally be implemented as a part of a number of hardware systems. As examples, the block access circuitry and the sets of circuitry block unit cells (along with auxiliary circuitry for the circuitry block unit cells) described herein may be implemented as a part of any electronic device such as a portable electronic device, a camera, a tablet computer, a desktop computers, a webcam, a cellular telephone, a video camera, a video surveillance system, an automotive imaging system, a video gaming system, or any other electronic device that may include or exclude imaging capabilities.

Configurations in which the block access circuitry, the sets of circuitry blocks, and the auxiliary circuitry for the set of circuitry blocks are formed as a part of an imaging system (e.g., are used to form a stitched image sensor) are described in detail herein as examples. However, this is merely illustrative. If desired, the block access circuitry, the sets of circuitry blocks, and the auxiliary circuitry for the set of circuitry blocks may be implemented in any of the above-mentioned systems or other systems (e.g., implemented as a part of a power management system, used to form output stages for a power management integrated circuit, used to form analog sensor arrays, etc.).

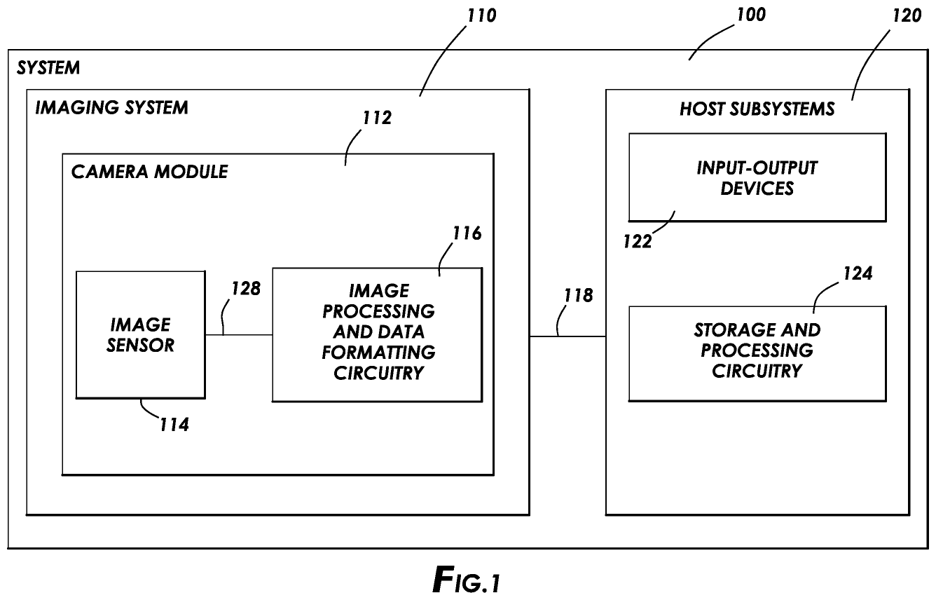

FIG. 1 is a diagram of an illustrative system including an imaging system that uses an image sensor to capture images. System 100 of FIG. 1 may be an electronic device such as a camera, a cellular telephone, a video camera, or other electronic device that captures digital image data, may be a vehicle safety system (e.g., an active braking system or other vehicle safety system) or other type of automotive system, may be a surveillance system, etc.

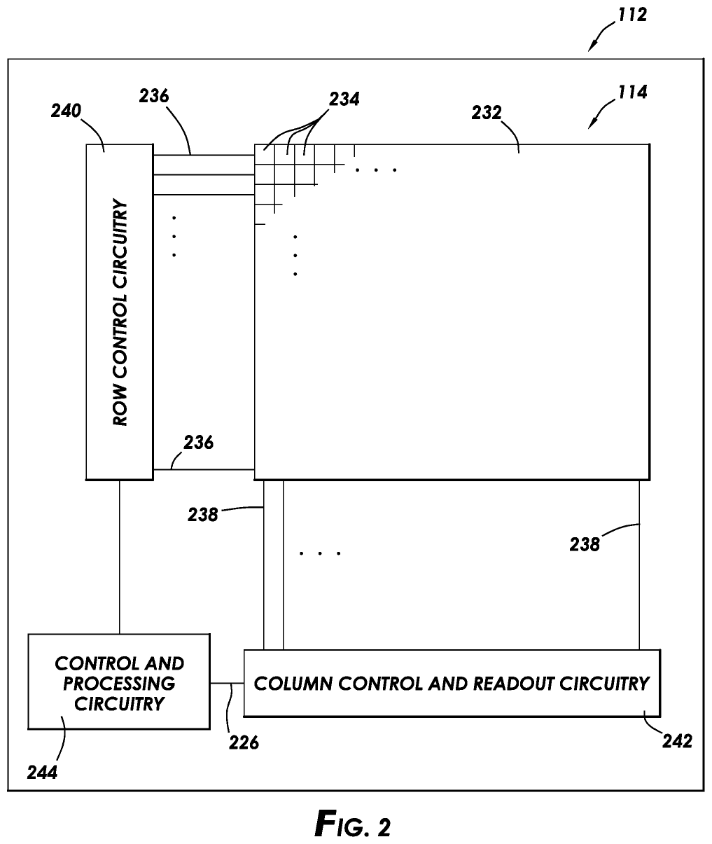

As shown in FIG. 1, system 100 may include an imaging system such as imaging system 110 and host subsystems such as host subsystem 120. Imaging system 110 may include camera module 112. Camera module 112 may include one or more image sensors 114 and one or more lenses. Each image sensor 114 in camera module 112 may be identical or there may be different types of image sensors 114 in a given image sensor array integrated circuit. During image capture operations, each lens may focus light onto an associated image sensor 114 such as the image sensor shown in FIG. 2.

Still and video image data from image sensor 114 may be provided to image processing and data formatting circuitry 116 via path 128. Image processing and data formatting circuitry 116 may be used to perform image processing functions such as data formatting, adjusting white balance and exposure, implementing video image stabilization, face detection, etc. Image processing and data formatting circuitry 116 may also be used to compress raw camera image files if desired (e.g., to Joint Photographic Experts Group or JPEG format).

In an exemplary arrangement, which is sometimes referred to as a system on chip (SOC) arrangement, image sensor 114 and image processing and data formatting circuitry 116 may be implemented on a common semiconductor substrate (e.g., a common silicon image sensor integrated circuit die). If desired, image sensor 114 and image processing circuitry 116 may be formed on separate semiconductor substrates. For example, image sensor 114 and image processing circuitry 116 may be formed on separate substrates that have been stacked.

Imaging system 110 (e.g., image processing and data formatting circuitry 116 in imaging system 110) may convey acquired image data to host subsystem 120 over path 118. Host subsystem 120 may include processing software instructions for detecting objects in images, detecting motion of objects between image frames, determining distances to objects in images, filtering or otherwise processing images provided by imaging system 110.

If desired, system 100 may provide a user with numerous high-level functions. In a computer or advanced cellular telephone, for example, a user may be provided with the ability to run user applications. To implement these functions, host subsystem 120 of system 100 may have input-output devices 122 such as keypads, input-output ports, joysticks, and displays and storage and processing circuitry 124. Storage and processing circuitry 124 may include volatile and nonvolatile memory (e.g., random-access memory, flash memory, hard drives, solid-state drives, etc.). Storage and processing circuitry 124 may also include microprocessors, microcontrollers, digital signal processors, application specific integrated circuits, etc.

An example of an arrangement for camera module 112 of FIG. 1 is shown in FIG. 2. As shown in FIG. 2, camera module 112 may include image sensor 114 and control and processing circuitry 244. Control and processing circuitry 244 may include and/or be included by image processing and data formatting circuitry 116 in FIG. 1. Image sensor 114 may include a pixel array such as array 232 of pixels 234 (sometimes referred to herein as image sensor pixels or image pixels) and may also include control circuitry 240 and 242. Control and processing circuitry 244 may be coupled to row control circuitry 240 and may be coupled to column control and readout circuitry 242 via data path 226. Row control circuitry 240 may receive row addresses from control and processing circuitry 244 and may supply corresponding row control signals to image pixels 234 over control paths 236 (sometimes be referred to as row lines).

Column control and readout circuitry 242 may be coupled to the columns of pixel array 232 via one or more conductive lines such as column lines 238. Each column lines 238 may be coupled to a corresponding column of image pixels 234 in image pixel array 232. Column lines 238 may be used for reading out image signals from image pixels 234 and/or for supplying bias signals (e.g., bias currents or bias voltages) to image pixels 234.

During image pixel readout operations, a pixel row in image pixel array 232 may be selected using row control circuitry 240, and image data associated with image pixels 234 of that pixel row may be read out by column control and readout circuitry 242 on column lines 238.

Column control and readout circuitry 242 may include column circuitry such as column amplifiers for amplifying signals read out from array 232, sample and hold circuitry for sampling and storing signals read out from array 232, analog-to-digital converter circuits for converting read out analog signals to corresponding digital signals, and column or frame memory for storing the read out signals and any other desired data. Column control and readout circuitry 242 may pass or output digital pixel values to control and processing circuitry 244 over line 226.

Array 232 may have any number of rows and columns. In general, the size of array 232 and the number of rows and columns in array 232 will depend on the particular implementation of image sensor 114. While rows and columns are generally described herein as being horizontal and vertical, respectively, rows and columns may refer to any grid-like structure (e.g., features described herein as rows may be arranged along a first direction and features described herein as columns may be arranged along a second direction that is non-parallel to the first direction).

Pixel array 232 may be provided with a color filter array having multiple color filter elements, which allows a single image sensor to sample light of different colors. As an example, image sensor pixels such as the image pixels 234 in array 232 may be provided with a color filter array that allows a single image sensor to sample red, green, and blue (RGB) light using corresponding red, green, and blue image sensor pixels arranged in a Bayer mosaic pattern. In another suitable example, the green pixels in a Bayer pattern may be replaced by broadband image pixels having broadband color filter elements (e.g., clear color filter elements, yellow color filter elements, etc.). These examples are merely illustrative and, in general, filter elements of any desired color or wavelength and in any desired pattern may be formed over any desired number of image pixels 234.

In some applications, image sensors 114 as shown in FIG. 1 (e.g., implemented using one or more of image sensors 114 in FIG. 2) may be implemented as a stitched image sensor (die), in which the same image sensor circuitry template is used to from multiple repeating units of image sensor circuitry (e.g., multiple circuitry block unit cells). As an example, a template for a pixel array such as pixel array 232 in FIG. 2 may be used as a template to form multiple sets of pixel arrays for multiple image sensors 114 in a system (e.g., system 100 in FIG. 1). In other applications, other portions of system 100 or other electronic systems may be fabricated using the “stamp and repeat” process to form systems having multiple circuitry block unit cells.

FIG. 3 is a diagram of an illustrative system formed from circuitry block unit cells. In particular, as shown in FIG. 3, system 300 may be formed from circuitry blocks 302-1, 302-2, 302-3, . . . , 302-N. System 300 may be used to form one or more portions of imaging system 110 (in FIG. 1), host subsystems 120 (in FIG. 1), power management systems, or other suitable systems. Configurations in which each circuitry block 302 includes one or more of image sensor pixel array circuitry (e.g., array 232 in FIG. 2), row control circuitry (e.g., row control circuitry 240 in FIG. 2), column control and readout circuitry (e.g., column control and readout circuitry 242 in FIG. 2), and other control and/or processing circuitry (e.g., control and processing circuitry 244 in FIG. 2) are described herein as examples. These examples are merely illustrative. If desired, each circuitry block 302 may include any suitable type of circuitry.

Circuitry block unit cells 302 may be identical to one another (e.g., identical in function, in structure, in routing and placement of the structure, etc.). If desired, circuitry block unit cells 302 may be identical when fabricated, but may be customizable after fabrication. Each of circuitry block unit cells 302 may sometimes be referred to herein as a unit cell, a unit cell structure, a stamp-and-repeat structure, or a circuitry block.

Each of circuitry block 302 may include a corresponding feature 330 (e.g., circuitry block 302-1 may include feature 330-1, circuitry block 302-2 may include features 330-2, etc.) and additional features. Features 330-1, 330-2, 330-3, . . . , 330-N may all be identical features (e.g., identical in function, in structure, in routing and placement of the structure, etc.). Feature 330 may be any suitable feature within the corresponding circuitry block 302 and may be configured to receive signals from and/or pass signals to systems or circuitry external to system 300. In general, features 330 may be a circuit configured to receive a control signal that controls the circuit, a circuit configured to receive a data signal for storage and/or processing, or any other suitable circuits. Feature 330 may sometimes be referred to herein as local circuitry (e.g., circuitry local to its corresponding circuitry block).

As an example, features 330 may be or include analog circuits formed from one or more of components such as resistors, capacitors, inductors, diodes, transistors, amplifiers, switches, and/or other adjustable circuitry exhibiting a variable capacitance, resistance and/or inductance. As another examples, features 330 may be or include digital circuits formed from one or more of components such as logic gates, transistors or switches, latches, and/or registers. As yet other examples, feature 330 may be analog or digital processing circuitry, memory circuitry, control circuitry, image sensor array circuitry, power management output circuitry, or any other suitable functional circuitry.

To support the functions of circuitry blocks 302, system 300 may also include left-hand edge circuitry 304 and right-hand edge circuitry 306 (sometimes referred to herein collectively as edge circuitry). Edge circuitry 304 and 306 may include auxiliary circuitry for supporting the functions of one or more circuitry blocks 302. As an example, edge circuitry 304 and/or 306 may include (data) interface circuitry configured to route signals onto system 300 (e.g., to one or more of circuitry blocks 302, from a source external to system 300) through one or more corresponding data paths, and/or route signals off of system 300 (e.g., to a source external to system 300, from one or more circuitry blocks 302) through one or more corresponding data paths. As other examples, edge circuitry 304 and/or 306 may include power supply circuitry, clock generation circuitry, driver circuitry, control circuitry, etc. If desired, system 300 may include top and/or bottom edge circuitry in addition to or instead of right-hand and left-hand edge circuitry. The top and bottom edge circuitry may serve similar functions as edge circuitry 304 and 306.

In systems formed from stamp-and-repeat structures (e.g., system 300), it may be difficult to flexibly access or address only a subset of stand-and-repeat structures. In other words, in a system having identical multiple features (e.g., features 330) in corresponding circuitry blocks (e.g., circuitry blocks 302), it may be difficult to access or address (e.g., read from, write into, or control) a feature in one or more of the circuitry blocks (e.g., feature 330-2 in circuitry block 302-3) without disturbing or accessing the same corresponding features in the other circuitry blocks (e.g., features 330-1, 330-2, 330-N, etc.) as each of the circuitry blocks have identical features and may be indistinguishable from each other. As particular examples, it may be difficult to activate one of the circuitry blocks while keeping the remaining circuitry blocks inactive, it may be difficult to operate one or more of the circuitry blocks with different settings or modes, etc. While fixed routing schemes may be employed to provide individualized and hardwired access to each block, these fixed routing configurations are inflexible and lack scalability, among other issues.

To provide flexible access to the circuitry blocks, systems such as system 300 may include circuitry block access circuitry (sometimes referred to as block access circuitry). The block access circuitry may sometimes be referred to as being separate from the circuitry blocks, may be referred to as being part of the circuitry blocks, may have portions forming the circuitry blocks, etc. Still referring to FIG. 3, system 300 show an exemplary configuration for block access circuitry that includes a serial chain of latches 310 coupled along a serial path 314, one or more (parallel) data routing paths 324 (e.g., a common data bus 324) coupled a serial chain of data circuitry 320 coupled along data routing paths 324. In particular, edge circuitry 304 may include signal generation circuitry 312 (e.g., driver circuitry) for generating or driving an enable signal (e.g., signal Enable) onto a first end of enable signal path 314 (e.g., at the most upstream circuitry block 302-1) and signal generation circuitry 322 (e.g., driver circuitry 322) for generating or driving one or more data signals (e.g., signal(s) Data) onto a first end of data signal paths 324 (e.g., at the most upstream circuitry block 302-1). If desired, latches 310 may be formed from any other suitable type of data storage or memory circuitry and may be referred to herein sometimes as data storage circuits 310 or memory circuit 310.

As shown in FIG. 3, circuitry block 302-1 may include a first latch 310-1 in the serial latch chain that receives signal Enable. Signal Enable may supply an enable state to be stored at latch 310-1. Latch 310-1 may control data circuitry 320-1 (e.g., may control a latch, a logic gate, etc. in data circuitry 320-1) coupled to one or more data paths 324. Data circuitry 320-1 may thereby selectively provide signals or data to feature 330-1 depending on a state of latch 310-1 (e.g., depending on whether the enable state supplied by signal Enable activates data circuitry or disables data circuitry).

Circuitry block 302-2 may include a second latch 310-2 in the serial latch chain that receives signal Enable. Signal Enable may supply an enable state to be stored at latch 310-2 (e.g., through latch 310-1, after temporarily storing the enable state for latch 310-2 at latch 310-1 after a first clock cycle and subsequently passing the enable state for latch 310-2 to latch 310-2 after a second clock cycle). Latch 310-2 may control data circuitry 320-2 (e.g., a latch, a logic gate, etc. in data circuitry 320-2) coupled to one or more data paths 324. Data circuitry 320-2 may thereby selectively provide signals or data to feature 330-2 depending on a state of latch 310-2.

Because data circuitry 320-2 may receive an enable state from latch 310-2 independently from data circuitry 320-1 receiving another enable signal from latch 310-1, features 330-1 and 330-2 may receive signals or data independently of each other (e.g., one feature may receive data while the other feature may not receive the data, one feature may be enabled while the other feature may be disabled, etc.). In such a manner, block access circuitry may independently access the same corresponding features across different circuitry blocks.

Circuitry blocks 302-3, . . . , 303-N may similarly include corresponding latches 310 in the serial latch chain that receives corresponding enable states from signal Enable in a serial manner (e.g., through latches upstream from a given latch, by passing the enable states across the serial latch chain after a varying number of clock cycles). The corresponding latches 310 in circuitry blocks 302-3, . . . , 303-N may be coupled along enable signal path 314. Each latch 310 in circuitry blocks 302-3, . . . , 302-N may control a corresponding data circuitry 320 in the corresponding circuitry block. Data circuitry 320 in circuitry blocks 302-3, . . . , 302-N may be coupled to one or more data routing paths 324.

In a similar manner to that described for circuitry blocks 302-1 and 302-2, the corresponding enable states for latch 310-3, . . . , latch 310-N (and latches 310-1 and 310-2) may be loaded with varying enable state values (that are independent of each other. In a similarly manner to that described for circuitry blocks 302-1 and 302-2, the corresponding enable states for latch 310-3, . . . , latch 310-N may be used to control (through corresponding data circuitry 320) signal or data routing to corresponding features 330-3 and 330-N independently from each other and independently from data routing to other features 330 in other circuitry blocks 302.

As examples, a first set of enable states (e.g., a first set of enable bits, a first set of enable values, etc.) may be loaded onto one or more latches 310 (e.g., each latch of latches 310) to independently control corresponding local circuitry (e.g., corresponding feature 330) in circuitry blocks 302 in a first manner or mode, a second set of enable states (e.g., a second set of enable bits, a second set of enable values, etc.) may be loaded onto one or more latches 310 (e.g., each latch of latches 310) to independently control corresponding local circuitry in circuitry blocks 302 in a second different manner or mode, etc. If desired, each set of enable states may include N number of bits, each for one of the N number of latches 310. If desired, each set may include less than N number of bits. If desired, enable states may include multiple bits for each circuitry 310 (e.g., each latch 310 may represent a set of parallel latches coupled along multiple enable paths).

In some embodiments, block access circuitry may include data loop-back circuitry 326 (e.g., a conductive path) that connects a second end of enable signal path 314 (e.g., at the most downstream circuitry block 302-N) to a second end of data routing paths 324 (e.g., at the most downstream circuitry block 302-N). In general, data routing paths 324 may include one or more input data paths and/or one or more output data paths, may include one or more shared input and output paths, each conveying both input signals and output signals, etc. By connecting enable signal path 314 to data loop-back circuitry 326, signal Enable may be routed through one of the output data paths in routing paths 324 back to edge circuitry 304 or other edge circuitry (e.g., ultimately supplied to circuitry external to system 300, supplied to any suitable circuitry, etc. via data interface circuitry in the edge circuitry). This may advantageously provide observability for signal Enable and ensure the correct enable states are being supplied to latches 310 in the serial latch chain.

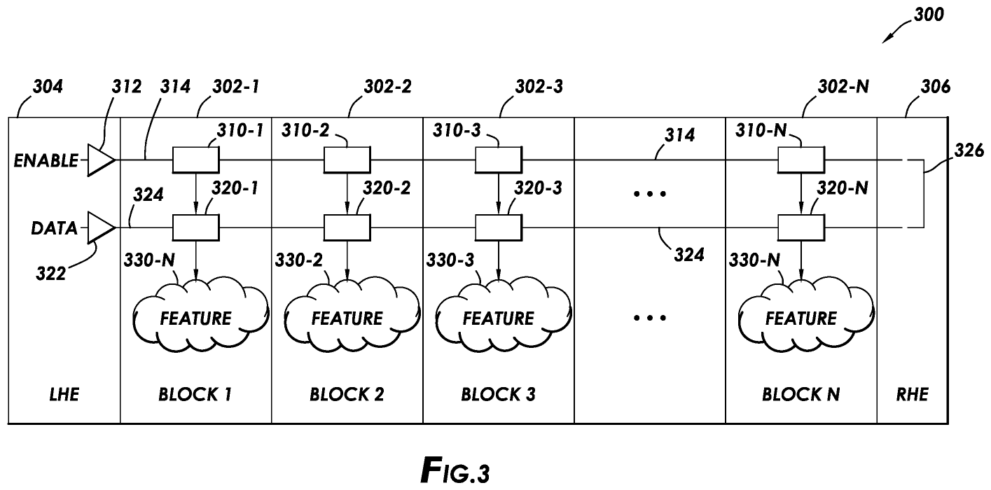

FIG. 4 is an illustrative timing diagram for operating block access circuitry such as the block access circuitry described in connection with FIG. 3. As shown in FIG. 4, signal Enable may exhibit assertions A, B, and C, and deassertions Z, Y, and X, that are propagated across a serial latch chain coupled along an enable signal path (e.g., enable signal path 314 in FIG. 3). Common clock signal Clock may be received at each of the latches in the serial latch chain (e.g., latches 310 in FIG. 3). These latches (e.g., latches 310) may store different logical states (e.g., may store a logic ‘0’ value or a logic ‘1’ value) based on the toggling of signal Clock and corresponding assertions and deassertions in signal Enable.

During each clock cycle, a new enable assertion or deassertion value may be loaded onto the latch chain at a first latch, latches may shift their values downstream by one latch, and a last latch in the latch chain may output its stored value. After a suitable number of clock cycles (e.g., after N number of clock cycle corresponding to N number of circuitry blocks 302 in FIG. 3), each latch may be loaded or programmable with a corresponding appropriate logical state (e.g., a corresponding appropriate enable state used to access local circuitry in that circuitry block).

The illustrative timing diagram of FIG. 4 may be described herein to operate an illustrative system having five circuitry block unit cells, as an example. For example, in FIG. 3, circuitry block 302-N may be circuitry block 302-5 and circuitry block 302-4 (not explicitly shown in FIG. 3) may be interposed between circuitry blocks 302-3 and 302-5.

In the illustrative example with five circuitry blocks (e.g., implemented with circuitry blocks 302-1, 302-2, 302-3, 302-4, and 302-5 in FIG. 3), loading a new set of enable bits into latches in the five circuitry blocks may start at time t0 in FIG. 4 (e.g., assertion A may be associated with a previous set of loaded enable bits). During a first clock cycle, deassertion Z of signal Enable (e.g., corresponding to a ‘0’ logic state ultimately destined for latch 310-5 in a fifth and most downstream circuitry block in circuitry block 302-5) may be loaded onto and stored at latch 310-1 in a first and most upstream circuitry block 302-1. During a second clock cycle, deassertion Z may be passed to and stored at latch 310-2 in a second (i.e., second-most upstream) circuitry block 302-2, while deassertion Y of signal Enable (e.g., corresponding to a ‘0’ logic state ultimately destined for latch 310-4 in a fourth and second-most downstream circuitry block 310-4) may be loaded onto and stored at latch 310-1 in the first circuitry block 302-1. During a third clock cycle, deassertion Z may be passed to and stored at latch 310-3 in a third (middle) circuitry block 302-3, deassertion Y may be passed to and stored at latch 310-2 in the second circuitry block 302-2, while assertion B of signal Enable (e.g., corresponding to a ‘1’ logic state ultimately destined for the latch 310-3 in the third circuitry block 302-3) may be loaded onto and stored at latch 310-1 in the first circuitry block 302-1.

In a similar manner, during the following fourth and fifth clock cycles, deassertion X and assertion C of signal Enable (e.g., ultimately destined for latches 310-1 and 310-2 in corresponding circuitry blocks 302-1 and 30-2, respectively) may be sequentially passed along serial path 314 (along with deassertion Z, deassertion Y, and assertion B) to their destination latches. After the five clock cycles, the desired logical states (assertions and deassertions destined for the corresponding latches) may be stored at the destination latches.

This stream of bits for signal Enable (sometimes referred to herein as an enable bitstream) may be passed along enable signal path 314 and may ultimately load a desired set of bit values to all of the latches 310 in corresponding blocks 302 (e.g., in a serial or sequential manner after a suitable number of clock cycles). In above example with five circuitry blocks, after all of the bits have been passed to their destination latches (e.g., at time t1, after five clock cycles), latch 310-5 may store a logic ‘0’ state (corresponding to deassertion Z), latch 310-4 may store a logic ‘0’ state (corresponding to deassertion Y), latch 310-3 may store a logic ‘1’ state (corresponding to assertion B), latch 310-2 may store a logic ‘0’ state (corresponding to deassertion X), and latch 310-1 may store a logic ‘1’ state (corresponding to assertion C).

After all of latches 310 store their corresponding programmed state (at time t1), signal Data In may provide ‘data’ onto a common data path or bus (e.g., data routing path 324 in FIG. 3). The ‘data’ on the common data bus may be made available to any of the circuitry blocks 302 (e.g., to any of the features 330). However, the state of the latches 310 in corresponding circuitry blocks 302 may determine which of the circuitry blocks 302 (e.g., which of the features 330) can access to the ‘data’. In particular, when signal Strobe is asserted (e.g., at the rising edge of assertion E) at time t1, the ‘data’ on the common data path or bus may be captured and received by features 330 in circuitry blocks 302 with corresponding latches 310 storing an enabling or activation state (e.g., a ‘1’ logic state). In the particular example above, when signal Strobe is asserted, the ‘data’ on the common data path or bus may be received and/or stored by features 330-1 and 330-3 associated latches 310 storing a ‘1’ logic state (but not by feature 330-2, 330-4, and 330-5 associated with latches 310 storing a ‘0’ logic state). Consequently, corresponding local circuitry in circuitry blocks 302-1 and 302-3 (e.g., features 330-1 and 330-3) may update their stored local data from a previously stored data (e.g., data₋₁) to the ‘data’.

The examples described in connection with FIGS. 3 and 4 are merely illustrative. If desired, system 300 in FIG. 3 may include any suitable number of circuitry blocks 302. If desired, each circuitry block 302 may include multiple sets of features (e.g., may include features additional to feature 330). If desired, each feature may have (e.g., be coupled to) one or more corresponding enable signal paths, one or more corresponding enable latches, one or more data routing paths, and/or any other suitable circuitry. If desired, one or more features may share one or more portions of the block access circuitry (e.g., two features may receive data from or output data to the same data routing path, two features may be controlled based on a state of the same enable latch, etc.). If desired, one feature may be controlled by multiple sets of enable latches (e.g., a feature may receive data when two or more enable latches are in an enabled state).

If desired, any suitable data routing structure (e.g., data input paths, data output paths, paths formed from a data bus, data paths along which latches are interposed) may be used to form data routing paths 324. If desired, data routing paths may not be common or shared across all of the circuitry blocks. If desired, any other suitable modifications may be made to system 300.

If desired, any suitable number of enable bits (e.g., any suitable pattern of assertions and deassertions for an enable signal) may loaded into any suitable number of enable latches in any suitable number of clock cycles before data is read from a common data path or bus. As an example, in a system with N number of circuitry blocks 302, a number of clock cycles fewer than N may be used to load enable bits across a subset of the circuitry blocks. If desired, any other suitable modifications may be made to the configured and/or operation of systems having circuitry blocks (e.g., system 300).

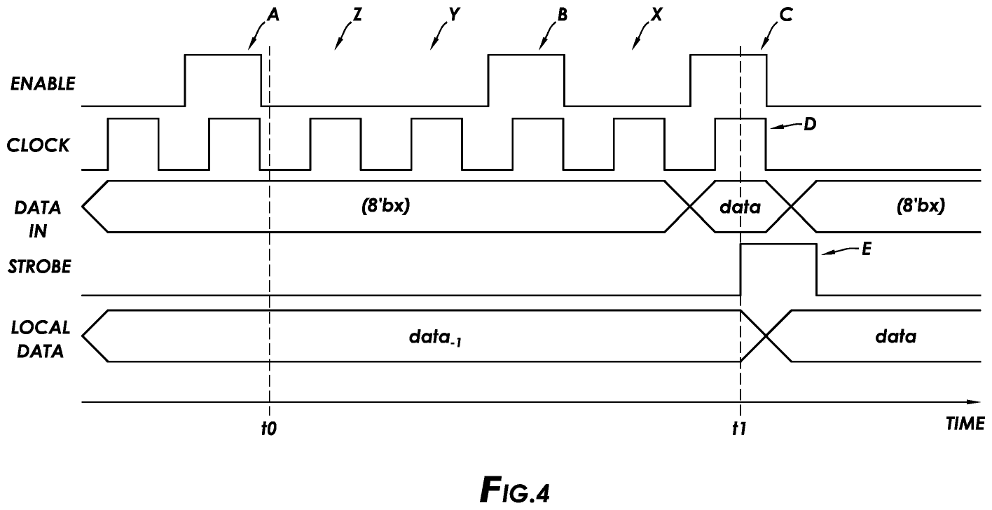

FIG. 5 is a circuit diagram showing an illustrative implementation of a portion of block access circuitry such as the chain of latches 310 in the block access circuitry in connection with FIG. 3. In particular, latches 310 in FIG. 3 may correspond to (e.g., may be implemented by) flip-flops 502 in FIG. 5. In the example of FIG. 5, each circuit block 302 may include a corresponding flip-flop 502 (e.g., a D-type flip-flop). Each flip-flop 502 may have a data input terminal D that receives a corresponding enable signal along signal path 314. Each flip-flop 502 may have a clock input terminal that receives the same shared clock signal Clock along clock signal line 504. Each flip-flop 502 may receive the enable signal from a (non-inverted) data output terminal Q of a preceding flip-flop and may output the enable signal at its (non-inverted) data output terminal Q based on the toggling of signal Clock. If desired, (local) circuitry (e.g., features such as a feature 330 in FIG. 3) within a given circuitry block 302 may be coupled to a corresponding flip-flop 502 and may receive the enable signal at the output terminal Q (and/or at the inverted output terminal) of the corresponding flip-flop 502 in the given circuitry block 302. If desired, any suitable type of flip-flops and/or other types of data storage circuits may be used to implement data storage circuits 310.

FIG. 6 is an illustrative timing diagram for operating a block access circuitry portion such as the serial latch chain of the type shown in FIG. 5. As shown in FIG. 6, signal Clock may be continually toggled (e.g., forming a plurality of clock cycles) to pass or propagate assertions and deassertions of signal Enable across a latch chain (e.g., along which flip-flops 502 in FIG. 5 are coupled) in a serial manner. In particular, assertions F, G, and H may be ultimately destined for one or more flip-flops in the latch chain (e.g., for three different flip-flops 502 in three corresponding circuitry blocks 302, which are programmed to be accessed by block access circuitry).

As an example, assertions F, G, and H, which are supplied onto enable signal path 314 at different clock cycles of signal Clock, may belong to a same set of enable bits used to simultaneously access a subset of circuitry blocks 302. In this example, assertion F may be ultimately destined for a flip-flop more downstream (e.g., further from the end at which signal Enable is supplied onto signal path 314) than a flip-flop for which assertion G is ultimately destined, and similarly, assertion G may be ultimately destined for a flip-flop more downstream than a flip-flop for which assertion H is ultimately destined. If desired, assertions F, G, and H, and corresponding deassertions may be supplied to circuitry blocks 302 in any suitable manner.

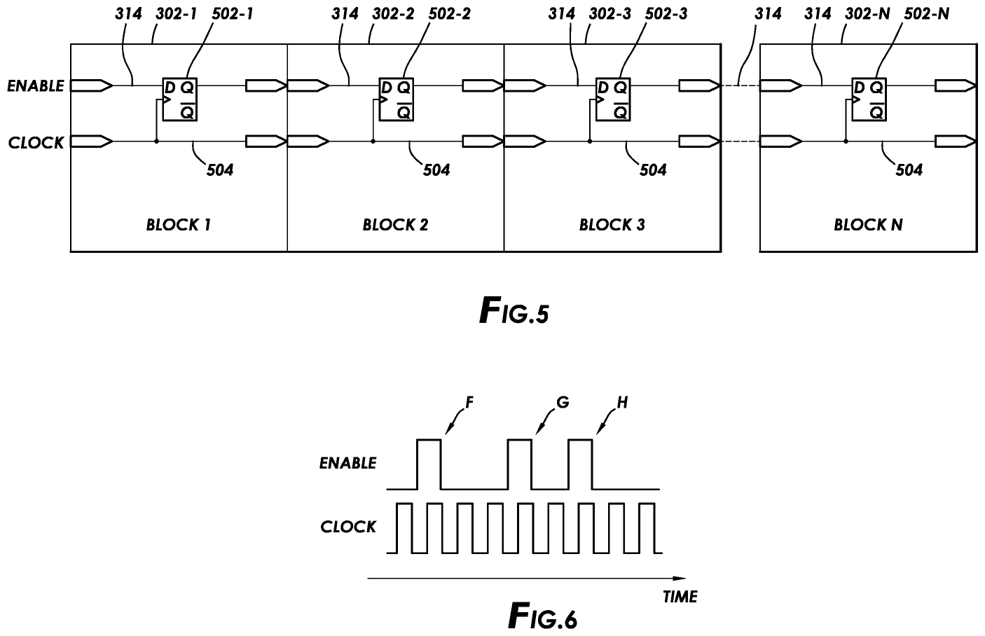

FIG. 7 is a circuit diagram showing an illustrative implementation of a portion of block access circuitry such as data circuitry 320 in the block access circuitry in connection with FIG. 3. In particular, the illustrative portion of block access circuitry shown in FIG. 7 may include data write circuitry, which is sometimes referred to herein as data input circuitry (e.g., formed as part of data circuitry 320). The data write circuitry may selectively write data onto or generate and supply external data or signals onto one or more of local circuitry in corresponding circuitry blocks (e.g., onto some of features 330 on corresponding circuitry blocks 302). The data write circuitry may include logic AND gates 702-1, 702-2, 702-3, . . . , 702-N, flip-flops 706-1, 706-2, 706-3, . . . , 706-N, and any other suitable circuitry.

The (non-inverted) output of each flip-flop in the chain of flip-flops 502 (e.g., as similarly described in FIG. 5) may be coupled to a first input terminal of a corresponding logic AND gate 702 in the same circuitry block 302. A second input terminal of each logic AND gate 702 may receive a shared strobe signal (e.g., signal Strobe on signal path 704). An output terminal of each logic AND gate 702 may be coupled to a clock input terminal of a corresponding flip-flop 706. Each flip-flop 706 may have a data input terminal coupled to one or more shared data input paths 708 (e.g., a data bus shared by and/or connected to all of the circuitry blocks 302).

If desired, corresponding registers may be used instead of flip-flops 706 to receive data from multiple data input paths. If desired, the one or more shared data input paths 708 may form at least a portion of data routing paths 324 in FIG. 3. Logic AND gates 702 and flip-flops 706 may form at least a portion of data circuitry 320 in FIG. 3 (sometimes referred to herein as data logic circuitry or logic circuitry).

A non-inverted (or inverted) data output terminal for each flip-flop 706 may be coupled to local circuitry (e.g., feature 330 in FIG. 3) in the corresponding circuitry block 302. The data output terminal for each flip-flop 706 may provide the data from one or more paths 708 to the local circuitry as local data, when its clock input is toggled (e.g., based on the output signal of the corresponding logic AND gate 702. As examples, data on one or more data paths 708 may be generated by or supplied by edge circuitry (e.g., edge circuitry described in connection with FIG. 3) or may be passed from circuitry external to the edge circuitry through data interface circuitry in the edge circuitry.

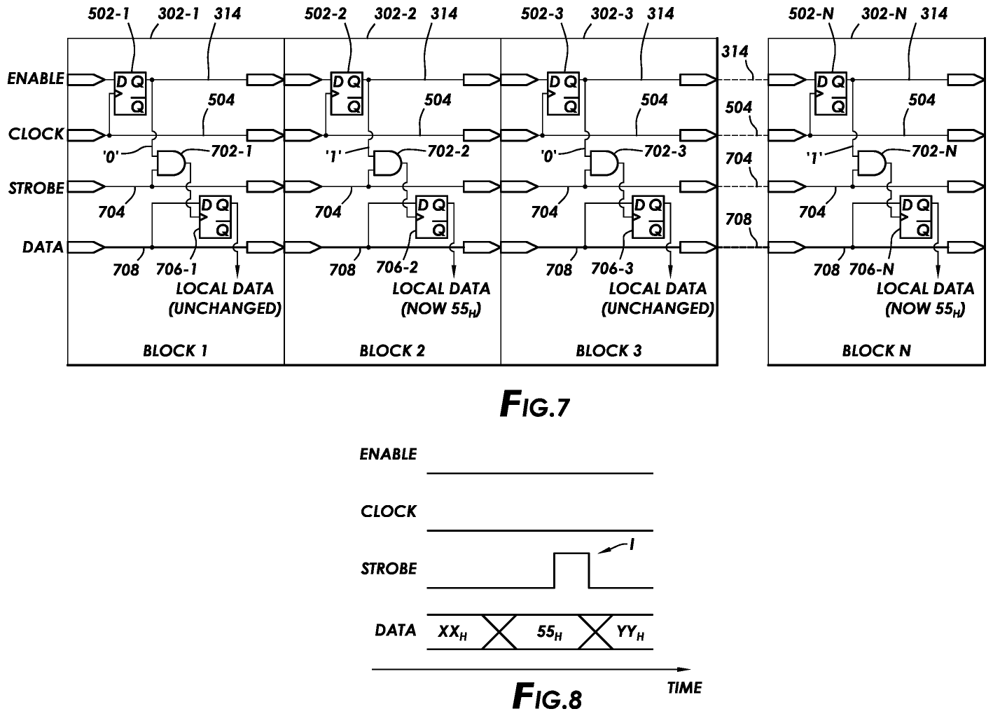

FIG. 8 is an illustrative timing diagram for operating a block access circuitry portion such as the data input circuitry of the type shown in FIG. 7. As shown in FIG. 8, signal Clock for the serial latch chain (e.g., chain of latches 502 in FIG. 7) may stop toggling at this time, as the appropriate values may already be stored at each of latches 502 in the corresponding circuitry block 302 (e.g., circuitry blocks 302 may have already performed the operations described in FIG. 6). In the example shown in FIG. 7, flip-flops 502-1 and 502-3 may store a ‘0’ logic value and output the stored logic value to corresponding logic AND gates 702, and flip-flops 502-2 and 502-N may store a ‘1’ logic value and output the stored logic value to corresponding logic AND gates 702.

Configured in such a manner, logic AND gates 702-2 and 702-N may output a ‘1’ logic value when signal Strobe is asserted (e.g., with assertion I). The asserted output of logic AND gates 702-2 and 702-N may respectively clock flip-flops 706-2 and 706-N to store data from one or more paths 708 and output the stored data as local data. As shown in FIG. 8, at assertion I, signal Data may provide data 55H over one or more path 708. As shown in FIG. 7, the local data output by flip-flops 706-2 and 706-N may both be updated to data 55H, whereas local data output by flip-flops 706-1 and 706-3 may remain unchanged (e.g., at one or more previous data values).

FIG. 9 is a circuit diagram showing an illustrative implementation of a portion of block access circuitry such as data circuitry 320 in the block access circuitry in connection with FIG. 3. In particular, the illustrative portion of block access circuitry shown in FIG. 9 may include data read circuitry, which is sometimes referred to herein as data output circuitry (e.g., in data circuitry 320). The data read circuitry may selectively read data from or pass one or more signals out of one or more of circuitry blocks 302. The data read circuitry may include logic AND gates 702-1, 702-2, 702-3, . . . , 702-N, logic AND gates 902-1, 902-2, 902-3, . . . , 902-N, driver circuitry 904-1, 904-2, 904-3, . . . , 904-N, and any other suitable circuitry.

The (non-inverted) output of each flip-flop in the chain of flip-flops 502 (e.g., as similarly described in FIG. 5) may be coupled to a first input terminal of a corresponding logic AND gate 702 in the same circuitry block 302. A second input terminal of each logic AND gate 702 may receive a shared strobe signal (e.g., signal Strobe on signal path 704). An output terminal of each logic AND gate 702 may be coupled to a first input terminal of a corresponding logic AND gate 902. A second input terminal for each logic AND gate 902 may receive a shared read-not-write signal (e.g., signal Rnw on signal path 906). An output terminal of each logic AND gate 902 may be coupled to a corresponding driver circuit, signal generation circuit, or pass-through circuit 904.

Based on the control input from the output terminal of each corresponding logic AND gate 902, the corresponding driver circuit 904 may pass local data (e.g., from local circuitry such as feature 330 in FIG. 3 within a corresponding circuitry block 302) onto one or more shared data output paths 908 (e.g., a data bus shared by and/or connected to all of the circuitry blocks 302). In other words, each driver circuit 904 may have an input terminal coupled to the local circuitry within the corresponding circuitry block 302 (e.g., a given feature 330 in the corresponding circuitry block 302) and an output terminal coupled to one or more data output paths 908.

If desired, the one or more shared data output paths 908 may form at least a portion of data routing paths 324 in FIG. 3. Logic AND gates 702, Logic AND gates 902, and driver circuits 904 may form at least a portion of data circuitry 320 in FIG. 3. If desired, logic AND gates 702-1, 702-2, 702-3, . . . , 702-N for data read circuitry in FIG. 9 may be shared with data write circuitry in FIG. 7 (e.g., logic AND gates 702-1, 702-2, 702-3, . . . , 702-N in FIGS. 7 and 9 may be the same). As examples, data on one or more data paths 908 may be supplied to edge circuitry (e.g., edge circuitry described in connection with FIG. 3) or may be passed to circuitry external to the edge circuitry through data interface circuitry in the edge circuitry.

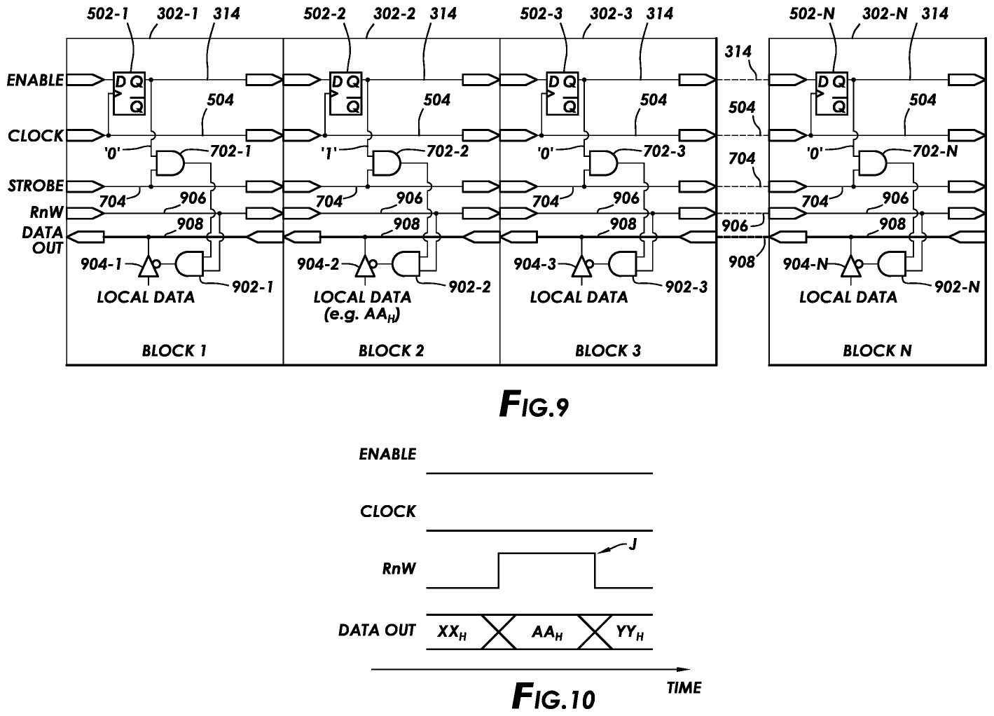

FIG. 10 is an illustrative timing diagram for operating a block access circuitry portion such as data output circuitry of the type shown in FIG. 9. As shown in FIG. 10, signal Clock for the serial latch chain (e.g., chain of latches 502 in FIG. 9) may stop toggling at this time, as the appropriate values may already be stored at each of latches 502 in the corresponding circuitry block 302 (e.g., circuitry blocks 302 may have already performed the operations described in FIG. 6). In the example shown in FIG. 9, flip-flops 502-1, 502-3, and 502-N may store a ‘0’ logic value and output the stored logic value to corresponding logic AND gates 702, and flip-flop 502-2 may store a ‘1’ logic value and output the stored logic value to a corresponding logic AND gate 702-2.

Configured in such a manner, logic AND gate 702-2 may output a ‘1’ logic value when signal Strobe is asserted. The asserted output of logic AND gates 702-2 in combination with an asserted signal Rnw (e.g., assertion J) may control driver circuit 904-2 to pass local data onto one or more data output paths 908. As shown in FIG. 10, at assertion J, signal Data Out may provide data AA_{H} over one or more data paths 908. In some embodiments, only data from a single circuitry block 302 may be read out at a time using a shared data bus (e.g., only one of latches 502 in the serial latch chain may store an asserted or activation state). In some embodiments, data from multiple circuitry blocks 302 may be read in parallel (e.g., using different lanes of a shared data bus).

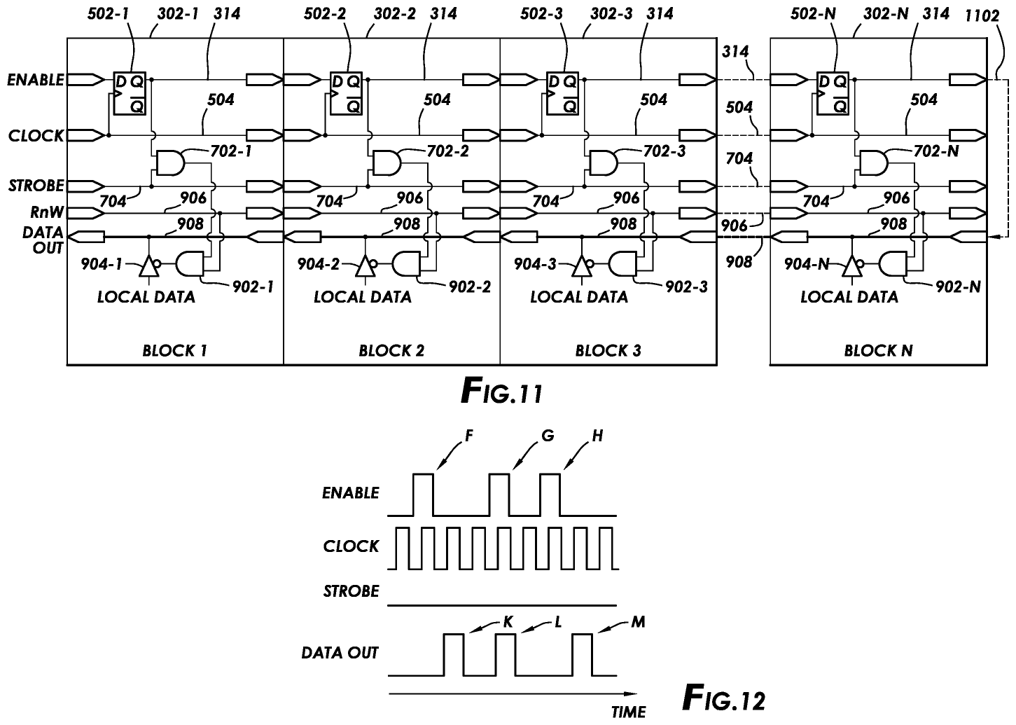

FIG. 11 is a circuit diagram showing an illustrative implementation of a portion of block access circuitry such as data circuitry 320 in the block access circuitry in connection with FIG. 3. In particular, the illustrative portion of block access circuitry shown in FIG. 11 may include a data loop-back circuit (e.g., corresponding to data loop-back circuitry 326). The data loop-back circuit may be implemented by a conductive path 1102 that connects an end of enable signal path 314 (at the most downstream circuitry block 302-N) to an end of a data output path 908 (at the most downstream circuitry block 302-N). In this way, an enable signal output from latch 502-N may be passed onto data output path 908 via data loop-back path 1102.

If desired, switching and/or enable circuitry may be coupled to loop-back path 1102 to selectively enable or disable path 1102. As an example, when local data is being passed from a circuitry block 302 onto output path 908, loop-back path 1102 may be disabled. As another example, when local data is not being passed from any circuitry block 302 onto output path 908, loop-back path 1102 may be enabled.

FIG. 12 is an illustrative timing diagram for operating a block access circuitry portion such as the data loop-back circuitry of the type shown in FIG. 11. As shown in FIG. 12, latches (e.g., latches 502 in the serial latch chain) receiving signal Enable may be clocked using signal Clock. As such, assertion and deassertion states may be conveyed to and stored at the chain of enable signal latches (e.g., latches 502-1, 502-2, etc. in FIG. 11). Additionally, using loop-back path 1102, signal Enable may be passed out of circuitry blocks 302 and onto output path 908 as signal Data Out. In such a manner, the authenticity and integrity of the enable states for each of the latches may be examined (e.g., in edge circuitry, in circuitry external to circuitry blocks 302, etc.). As shown in FIG. 12, signal Data Out may pass enable signal assertions K, L, and M (and similarly deassertions between the corresponding assertions).

If desired, loop-back path 1102 may be enabled (e.g., switched into use) during testing operations during which circuitry blocks 302 are not accessed. If desired, loop-back path 1102 may be enabled during the loading of enable signal states onto latches 502. As an example, assertions F, G, H may be part of a set of enable states loaded onto each of the latches 502 in the latch chain. During loading of this set of enable states, a set of enable states that is part of a previous set of enable states including assertions K, L, and M (e.g., previously stored at each of the latches in the latch chain) may be output from circuitry blocks 302 and passed through (e.g., looped back through) path 908. This is merely illustrative. If desired, any suitable operations may make use of loop back path 1102 in any suitable manner.

The configurations and operations of block access circuitry described in connection with FIGS. 5-12 are merely illustrative. If desired, some portions of block access circuitry (e.g., data loop-back circuitry) may be omitted. If desired, some portions of block access circuitry described in different figures may be implemented in combination (e.g., block access circuitry may implement data input and output circuitry described in connection with FIGS. 7 and 9) to form the block access circuitry. If desired, any suitable modifications may be made to the details described in connection with FIGS. 5-12.

Various embodiments have been described for illustrative systems and methods for selectively accessing circuitry blocks.

As an example, a system may include a first circuitry block having a first (local) circuit (e.g., a first feature), a second circuitry block having a second (local) circuit (e.g., a second feature), and any additional circuitry blocks, each having a corresponding (local) circuit or feature, the first, second, and corresponding circuits being identical to each other, and the circuitry blocks being identical to each other. The system may include block access circuitry that includes a serial chain of data storage circuits (e.g., latches). The serial chain of data storage circuits may include a first data storage circuit coupled to the first feature and configured to control access to the first feature, and a second data storage circuit coupled to the second feature and configured to control access to the second feature. The first and second data storage circuits may be coupled along an enable signal path that is configured to provide a first enable bit to the first data storage circuit and a second enable bit to the second data storage circuit. The system may further include a data signal path coupled to the first feature and coupled to the second feature. The first enable bit may control a connection between the first feature and the data signal path, and the second enable bit may control an additional connection between the second feature and the data signal path. The enable signal path is coupled to the data signal path via a loop-back path. First logic circuitry may be interposed between the first data storage circuit and the first feature, and second logic circuitry may be interposed between the second data storage circuit and the second feature. The first logic circuitry may include a first logic AND gate, and the second logic circuitry may include a second logic AND gate.

The block access circuitry may include data input circuitry configured to selectively provide data to the first feature and the second feature. The block access circuitry may include data output circuitry configured to selectively receive data from the first feature and the second feature. The system may include edge circuitry coupled to the first and second circuitry blocks. The first circuitry block may be interposed between the second circuitry block and the edge circuitry, and the edge circuitry may be configured to provide auxiliary functions for the first and second circuitry block and be configured to supply signals to the block access circuitry.

In other words, the first data storage circuit may be coupled to a first control circuit that selectively passes a first signal between the first local circuitry and the data signal path, and the second data storage circuit may be coupled to a second control circuit that selectively passes a second signal between the second local circuitry and the data signal path. The first control circuit and the second control circuit may each comprise digital logic circuitry, and the first and second data storage circuit may each comprise latch circuitry. The digital logic circuitry for each of the first and second control circuits may comprise at least a logic gate circuit. The digital logic circuitry for the first and second control circuits may comprise additional latch circuitry.

In other words, first latch circuitry may be configured to receive a clock signal, the first latch circuitry having an output terminal. Second latch circuitry may be configured to receive the clock signal, the second latch circuitry having an output terminal and having an input terminal coupled to the output terminal of the first latch circuitry. A data bus may be selectively connected to the first circuit based on an output signal at the output terminal of the first latch circuitry and selectively connected to the second circuit based on an output signal at the output terminal of the second latch circuitry. The first circuitry block may be identical to the second circuitry block. Edge circuitry may be disposed at a first edge, and additional edge circuitry may be disposed at a second edge that opposes the first edge. The first and second circuitry blocks may be interposed between the edge circuitry and the additional edge circuitry, and the data bus may extend from the edge circuitry to the additional edge circuitry.

The foregoing is merely illustrative of the principles of this invention and various modifications can be made by those skilled in the art. The foregoing embodiments may be implemented individually or in any combination.

What is claimed is:

1. An imaging system comprising:
a first circuitry block that includes image sensor circuitry having a first feature;
a second circuitry block that includes additional image sensor circuitry having a second feature that is identical to the first feature; and
block access circuitry that includes a serial chain of data storage circuits, the serial chain of data storage circuits having a first data storage circuit coupled to the first feature and configured to control access to the first feature, and a second data storage circuit coupled to the second feature and configured to control access to the second feature.

2. The imaging system defined in claim 1, wherein the first and second data storage circuits are coupled along an enable signal path that is configured to provide a first enable bit to the first data storage circuit and a second enable bit to the second data storage circuit.

3. The imaging system defined in claim 2, further comprising:
a data signal path coupled to the first feature and coupled to the second feature, wherein the first enable bit controls a connection between the first feature and the data signal path, and the second enable bit controls an additional connection between the second feature and the data signal path.

4. The imaging system defined in claim 3, wherein the first enable bit value is a first value, and the second enable bit value is a second value that is different from the first value.

5. The imaging system defined in claim 3, wherein the enable signal path is coupled to the data signal path via a loop-back path.

6. The imaging system defined in claim 1, wherein the first data storage circuit comprises a first latch, and the second data storage circuit comprises a second latch.

7. The imaging system defined in claim 1, wherein first logic circuitry is interposed between the first data storage circuit and the first feature, and second logic circuitry is interposed between the second data storage circuit and the second feature.

8. The imaging system defined in claim 7, wherein the first logic circuitry comprises a first logic AND gate, and the second logic circuitry comprises a second logic AND gate.

9. The imaging system defined in claim 1, wherein the block access circuitry comprises data input circuitry configured to selectively provide data to the first feature and the second feature.

10. The imaging system defined in claim 9, wherein the block access circuitry comprises data output circuitry configured to selectively receive data from the first feature and the second feature.

11. The imaging system defined in claim 1, wherein the image sensor circuitry comprises a first image sensor pixel array and first control circuitry coupled to the first image sensor pixel array, and the additional image sensor circuitry comprises a second image sensor array and second control circuitry coupled to the second image sensor pixel array.

12. The imaging system defined in claim 1, further comprising:
edge circuitry coupled to the first and second circuitry blocks, wherein the first circuitry block is interposed between the second circuitry block and the edge circuitry, the edge circuitry is configured to provide auxiliary functions for the first and second circuitry blocks, and the edge circuitry is configured to supply signals to the block access circuitry.

13. A system comprising:
first local circuitry in a first circuitry block;
second local circuitry in a second circuitry block, wherein the first local circuitry is identical to the second local circuitry;
an enable signal path;
a first data storage circuit coupled to the first local circuitry;
a second data storage circuit coupled to the second local circuitry, the first and second data storage circuits being coupled serially along the enable signal path; and
a data signal path coupled to the first local circuitry and the second local circuitry, wherein the first data storage circuit is coupled to a first control circuit that selectively passes a first signal between the first local circuitry and the data signal path, and the second data storage circuit is coupled to a second control circuit that selectively passes a second signal between the second local circuitry and the data signal path.

14. The system defined in claim 13, wherein the first control circuit and the second control circuit each comprises digital logic circuitry, and the first and second data storage circuit each comprises latch circuitry.

15. The system defined in claim 14, wherein the digital logic circuitry for each of the first and second control circuits comprises at least a logic gate circuit.

16. The system defined in claim 15, wherein the digital logic circuitry for the first and second control circuits comprises additional latch circuitry.

17. A system comprising:
a first circuit in a first circuitry block;
a second circuit in a second circuitry block, the first circuit being identical to the second circuit;
first latch circuitry configured to receive a clock signal, the first latch circuitry having an output terminal;
second latch circuitry configured to receive the clock signal, the second latch circuitry having an output terminal and having an input terminal coupled to the output terminal of the first latch circuitry; and
a data bus that is selectively connected to the first circuit based on an output signal at the output terminal of the first latch circuitry and selectively connected to the second circuit based on an output signal at the output terminal of the second latch circuitry.

18. The system defined in claim 17, wherein the first circuitry block is identical to the second circuitry block.

19. The system defined in claim 17, further comprising:
edge circuitry at a first edge; and
additional edge circuitry at a second edge that opposes the first edge, wherein the first and second circuitry blocks are interposed between the edge circuitry and the additional edge circuitry, and the data bus extends from the edge circuitry to the additional edge circuitry.

20. The system defined in claim 19, further comprising:
a plurality of additional circuitry blocks, each having a corresponding circuit identical to the first and second circuits, wherein the data bus is selectively connected to each of the corresponding circuits in the plurality of additional circuitry blocks, and the plurality of additional circuitry blocks are interposed between the edge circuitry and the additional edge circuitry.
